(19) United States
(12) Patent Application Publication
(10) Pub. No.: US 2018/0137238 A1
(43) Pub. Date: May 17, 2018

(54) GENOMIC-BASED VIRUS DETECTION

(71) Applicant: SAP SE, Walldorf (DE)

(72) Inventors: Jens Odenheimer, Karlsruhe (DE); Udo Klein, Nussloch (DE)

(21) Appl. No.: 15/352,147

(22) Filed: Nov. 15, 2016

(51) Int. Cl. G06F 19/22

(52) U.S. Cl. CPC G06F 19/22

(57) ABSTRACT

A plurality of deoxyribonucleic acid (DNA) reads is received, where each DNA read represents a portion of a DNA sequence of a patient's DNA sample. The plurality of DNA reads is assembled into an aligned DNA sequence based on a human reference DNA sequence. At least one variant is identified by comparing the aligned DNA sequence to the human reference sequence, where each variant represents a difference between the aligned DNA sequence and the human reference sequence. A plurality of virus reference DNA sequences is received, where each virus reference sequence represents a DNA sequence of a virus. For each identified variant and each of the plurality of virus reference sequences, a correlation is computed between the variant and the virus reference sequence.

### BACKGROUND

A biological virus can be detected by testing antibodies generated in the body (for example, a human or animal body) in response to exposure to/infection by the specific virus. For example, a blood sample can be used to check for the generated virus-specific antibodies which would indicate at least exposure to the virus. However, this method has a number of drawbacks. First, each viral test typically checks for only one virus. For example, if a doctor wants to scan a patient for both influenza and Lyme disease, the doctor needs to order two distinct tests. Second, a long period of time may be needed to obtain test results because it takes time for a patient's immune system to develop antibodies after the patient has been exposed to a particular virus. Third, detection errors, such as false positives and false negatives, can occur with many diagnostic tests.

### SUMMARY

The present disclosure describes methods and systems, including computer-implemented methods, computer program products, and computer systems for genomic-based virus detection.

A plurality of deoxyribonucleic acid (DNA) reads is received, where each DNA read represents a portion of a DNA sequence of a patient's DNA sample. The plurality of DNA reads is assembled into an aligned DNA sequence based on a human reference DNA sequence. At least one variant is identified by comparing the aligned DNA sequence to the human reference sequence, where each variant represents a difference between the aligned DNA sequence and the human reference sequence. A plurality of virus reference DNA sequences is received, where each virus reference sequence represents a DNA sequence of a virus. For each identified variant and each of the plurality of virus reference sequences, a correlation is computed between the variant and the virus reference sequence.

The above-described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, the described approach can detect all viruses a patient has been infected with using one test. Second, the described approach can detect viruses within a short period of time. Third, the described approach can detect viruses with low error rates. Fourth, the described approach can identify all known viruses (for example, those can be found on private or public databases), as well as identify unknown viruses (for example, those cannot be found in any database) that infect the patient, by comparing different genome scans and observing unknown DNA sequence(s) occurred in the latest scan which was not in the previous scans. The unknown DNA sequence may be a new—yet unidentified—virus. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a flowchart illustrating an example method for genomic-based virus detection, according to an implementation.

FIG. 2 is a block diagram illustrating an example health system for genomic-based virus detection, according to an implementation.

FIG. 3 is a block diagram illustrating an example system for genomic-based virus detection, according to an implementation.

FIG. 4 is a block diagram illustrating an exemplary computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following detailed description describes genomic-based virus detection and is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

A biological virus can be detected by testing antibodies generated in the body (for example, a human or animal body) in response to exposure to/infection by the specific virus. For example, a blood sample can be used to check for the generated virus-specific antibodies which would indicate at least exposure to the virus. However, this method has a number of drawbacks. First, each viral test typically checks for only one virus. For example, if a doctor wants to scan a patient for both influenza and Lyme disease, the doctor needs to order two distinct tests. Second, a long period of time may be needed to obtain test results because it takes time for a patient's immune system to develop antibodies after the patient has been exposed to a particular virus. Third, detection errors, such as false positives and false negatives, can occur with many diagnostic tests.

At a high-level, the described approach is a distributed computing solution for biological virus detection. In a typical implementation, the described virus detection system (VDS) receives a patient's unaligned deoxyribonucleic acid (DNA) reads, where each DNA read is a portion of the patient's DNA sequence without a specification of where the read is located in the patient's overall DNA sequence. The VDS compares the DNA reads with a completely sequenced human reference DNA sequence (either the patient's or the DNA sequence of another individual) by aligning DNA reads with the reference DNA sequence. Variants in the DNA sample that do not align with the reference sample are identified (and bad data/signal qualities can also be filtered out of the usable data set). The identified variants are compared to previously-identified virus reference DNA sequences. An analysis is performed to determine a likelihood of a variant match to a virus reference DNA sequence actually corresponds to a specific biological virus. In typical implementations, the computational tasks of virus detection can be performed by a distributed computing system.

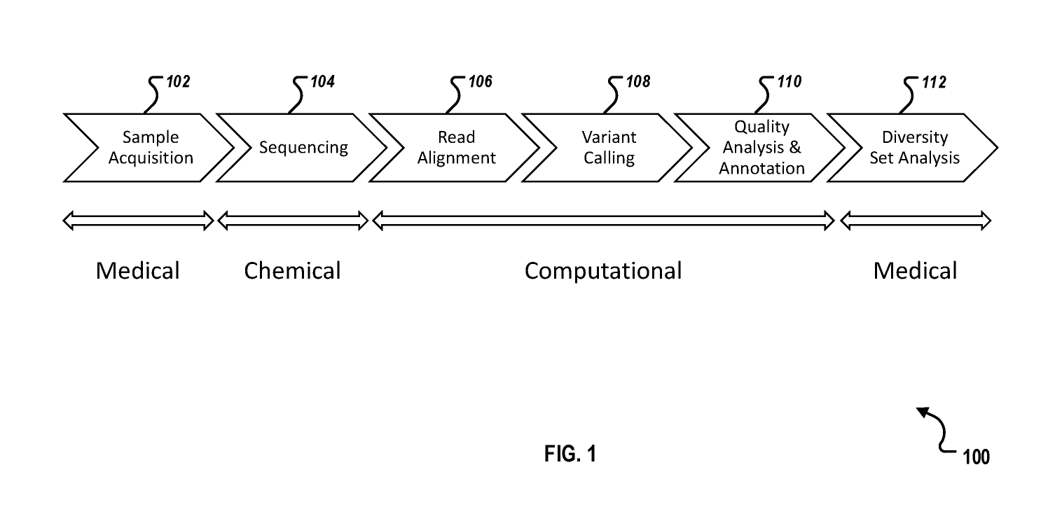

FIG. 1 is a flowchart illustrating an example method 100 for genomic-based virus detection, according to an implementation. For clarity of presentation, the description that follows generally describes method 100 in the context of the other figures in this description. However, it will be understood that method 100 or part of method 100 may be performed, for example, by any suitable system, environment, software, and hardware, or a combination of systems, environments, software, and hardware as appropriate. In some implementations, various steps of method 100 can be run in parallel, in combination, in loops, or in any order. The example method 100 typically includes illustrated steps 102, 104, 106, 108, 110, and 112, however each of the illustrated steps can be divided into one or more steps in other implementations. The described VDS typically performs at least steps 106, 108, 110, and 112, but other implementations can include functionality to perform one or more of the other steps.

At step 102, a patient's DNA sample is acquired. For example, the DNA sample can be any type of sample, such as blood, tissue, mucus, urine, and stool. In some cases, a patient may provide such samples on a regular basis, and it is sufficient to use such a previously obtained sample if the sample was taken within a particular time window of a potential viral incubation period (for example, if a patient is suspected of being exposed to a strain of influenza, the known incubation period of the particular influenza strain can be considered with respect to a previously-obtained DNA sample from the patient). From step 102, method 100 proceeds to step 104.

At step 104, a set of unaligned DNA reads (also called DNA snippets or reads) are generated for the DNA sample acquired at step 102 by using DNA sequencing. In a typical implementation, the entire genome of the acquired sample is sequenced within the set of unaligned DNA reads. Any method for DNA sequencing can be used, for example, Sanger sequencing, Pyrosequencing, Ion Torrent sequencing, and nanopore sequencing. In some cases, a sequencing lab (for example, in a hospital or custom laboratory) can perform the DNA sequencing. Each read represents a portion of the overall genomic DNA sequence and includes a string of characters (that is, one of the four letters C, G, A, and T, representing one of the four nitrogenous bases, cytosine (C), guanine (G), adenine (A), and thymine (T)). For example, results of the DNA sequencing can include 20,000 DNA reads, each read including a string of 10-200 characters. The DNA reads generated at step 104 are unaligned because the DNA reads do not provide information where each read is located in the overall DNA sequence. In other words, step 104 generates hundreds or thousands of short DNA sequences without specifying a particular order for the DNA reads. From step 104, method 100 proceeds to step 106.

At step 106, the VDS compares the unaligned DNA reads against a human reference DNA sequence, and aligns the DNA reads to form an aligned DNA sequence (also called genome). The human reference sequence can be a healthy human DNA sequence without viruses. In some cases, the human reference sequence can be a generic human sequence, for example, one of the human DNA sequences from one of the many human genomic sequencing projects (for example, the 1000 Genomes Project that provides DNA sequences of at least one thousand human participants). If the patient has previously provided a personal DNA sample that was sequenced, the patient's personal DNA sequence can optimally be used as the reference sequence. In some implementations, the human reference sequences can be stored in a database or other type of repository.

At step 106, the VDS assembles the unaligned DNA reads into an aligned DNA sequence based on the used human reference sequence. For example, the human reference sequence is AAGGCC, and there are three DNA reads, where the first read is CC, the second read is GG, and the third read is AA. By comparing the three reads with the reference sequence, the VDS will order the reads by having the third read AA at the first place, followed by the second read GG, and followed by the first read CC.

In some cases, even if some of the DNA reads may not be exactly same as the reference sequence, the VDS will assemble them. For a first example, a DNA read has AGGA while the reference sequence has ACGA, although AGGA and ACGA are not exactly the same, the VDS may align the AGGA in the read with the ACGA in the reference sequence because only the second character is different and the remaining three characters are the same (in this case, the variant character may be due to a known genomic difference that can occur between various individuals). For a second example, a DNA read has ACCGGAGA while the reference sequence has ACGA, although ACCGGAGA and ACGA are not the same, the VDS may align these two strings because the two strings have the same first two characters and the same last two characters and the only difference is the extra CGGA in the middle of the DNA read. For a third example, the DNA read has ACGA while the reference sequence has ACCGGAGA, the VDS may align these two strings because the two strings have the same first two characters and the same last two characters and the only difference is the missing CGGA in the middle of the DNA read. For a fourth example, there are two DNA reads, the first read having AGA and the second read having CCGGGC, and the reference sequence has CCCAAA. The VDS can align the second read CCGGGC to the first three characters CCC of the reference sequence because the only difference between the two strings is the extra GGG in the middle of the second read. The VDS can also align the first read AGA to the last three characters AAA of the reference sequence because the two strings are different in only one character. As a result, the VDS will assemble the two reads into an aligned sequence CCGGGCAGA. In some implementations, the VDS can align DNA reads based on multiple reference sequences. As will be understood by those of ordinary skill in the art, there are a multitude of considerations consistent with this disclosure that can be used to align DNA reads with a reference DNA sequence. Each of these considerations are considered to be within the scope of this disclosure. From step 106, method 100 proceeds to step 108.

At step 108, the VDS identifies DNA reads that do not align with the reference DNA (variants) against human reference DNA sequences. In some implementations, the VDS compares the aligned DNA sequence obtained at step 106 (also called sample DNA sequence) to a human reference DNA sequence, and identifies variants. A variant is recognized as a genetic difference in a DNA read or the sample DNA sequence compared to the human reference sequence. A variant may be only a single nucleotide or an entire new sequence (thousands of nucleotides). In other words, step 108 identifies non-human DNA that does not correspond to a portion of human DNA from the reference DNA sample. The variant sequence can be considered a possible viral DNA sequence to be compared against known viral DNA sequences. For example, the sample DNA sequence has AAGGGAA and the reference human sequence has AAAA, the VDS may determine that GGG is a variant and GGG could be a possible viral DNA sequence. Various methods can be used to identify variants, for example, Bayesian inference and other methods consistent with this disclosure. In some implementations, identified variants can be stored in a database or other type of repository for analysis. In some cases, the variants can be patient-specific and the VDS can treat the variants in a compliant manner for patient-related data. For example, the data can be stored in compliance with medical privacy regulations or if the particular human reference DNA sequence is based on a patient's previous DNA sample, identified variants can be linked to the patient's former genomic reference so that redundant genetic data need not be stored. From step 108, method 100 proceeds to step 110.

At step 110, the VDS analyses the quality of variants identified at step 108 and annotates individual variants. Step 110 can yield trustable variants and correlate with other data sources. For example, for each identified variant, the VDS compares the variant to virus reference DNA sequences (that is, known viral DNA sequences) and determines a likelihood of the variant being a viral DNA sequence. In a typical implementation, step 110 can generate a correlation matrix that captures the correlation between each variant and each virus. For example, Table 1 illustrates a correlation matrix of three rows and three columns, where each row represents a variant (a total of three variants), each column represents a virus (a total of three viruses, Influenza A, Hepatitis B, and Zika), and each element in the matrix represents the probability of a particular variant being a particular viral DNA sequence. The probability is typically a number between 0 and 1.

TABLE 1
Correlation matrix between variants and viruses

| | Virus | Virus | |
|---|---|---|---|
| Variant | Influenza A | Hepatitis B | Virus Zika |
| 1 | 0.99 | 0.00 | 0.01 |
| 2 | 0.01 | 0.97 | 0.00 |
| 3 | 0.00 | 0.01 | 0.98 |

Table 1 shows that for the a first variant (1), there is a 99% probability the first variant is an Influenza A virus, 0% probability of a Hepatitis B virus, and a 1% probability of the variant being a Zika virus. Therefore, all three variants can be considered trustable variants because of the high indicated probabilities of each being a particular virus. In some implementations, a variant can be considered a trustable variant if the probability of the variant being a specific virus is higher than a predefined threshold.

In some implementations, viral reference sequences of known viruses can be stored in a database or other type of repository. To reduce computational complexity, instead of parsing an entire sample DNA sequence (or the entire set of reads) and comparing to known virus reference sequences, the VDS only compares variants identified at step 108 to the known virus reference sequences. A human DNA sequence contains about 3.2 billion DNA base pairs, whereas an influenza DNA sequence has only about 13,500 DNA base pairs. By comparing the variants to the virus reference sequences, the VDS only needs to perform DNA string comparisons on the order of a couple thousand base pairs.

At step 112, the VDS performs a diversity set analysis. For example, the VDS can use the results from the previous steps, such as the correlation matrix from step 110, to assist the patient's physician to identify possible treatment options. For example, the VDS can determine probable virus(es) the patient has been exposed to/infected by based on the correlation matrix. In some implementations, the identified treatment option is persisted in the VDS so that this information may be used for future analysis. From step 112, method 100 stops.

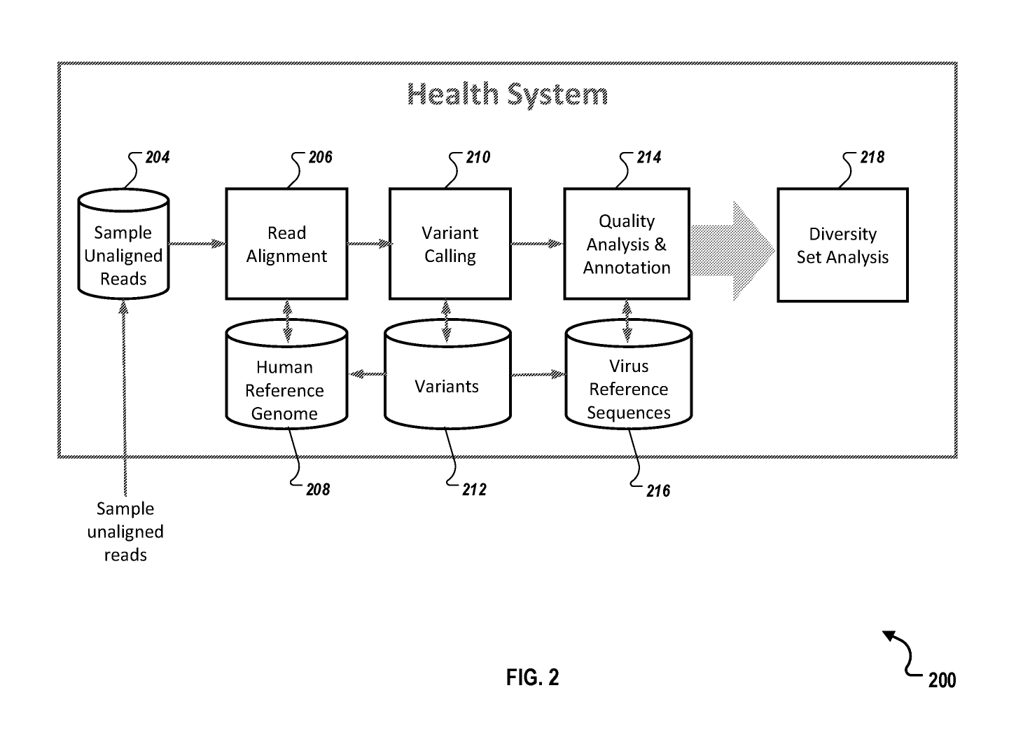

FIG. 2 is a block diagram illustrating an example health system 200 for genomic-based virus detection, according to an implementation. The example system 200 includes components performing functions related to read alignment 206, variant calling 210, quality analysis & annotation 214, and diversity set analysis 218. The system 200 also includes sample unaligned reads 204, human reference genome 208, variants 212, and virus reference sequences 216 that can be stored in one or more databases or other types of repositories. In some implementations, human reference genome 208 (that is, a human reference DNA sequence) and virus reference DNA sequences 216 can be stored either within or outside the health system 200 (for example, public cloud services for biotechnology information).

Read alignment 206 obtains the sample unaligned reads 204 (for example, unaligned DNA reads of a patient's sample obtained at step 104 of FIG. 1) and used human reference genome 208. Based on the used human reference genome 208, read alignment 206 aligns the sample unaligned reads 204 against the human reference genome 208 (as explained in step 106 of FIG. 1). Read alignment 206 sends the aligned reads to variant calling 210.

Variant calling 210 identifies variants in the sample DNA sequence (as explained in step 108 of FIG. 1). Variant calling 210 sends the identified variants 212 to quality analysis and annotation 214.

Based on the identified variants 212 and virus reference sequences 216, quality analysis and annotation 214 compares each variant to each virus reference sequence and determines a correlation matrix between the variants and the virus sequences (as explained in step 110 of FIG. 1). Quality analysis and annotation 214 sends the correlation matrix to diversity set analysis 218 which assists the patient's physician to identify possible treatment options (as explained in step 112 of FIG. 1).

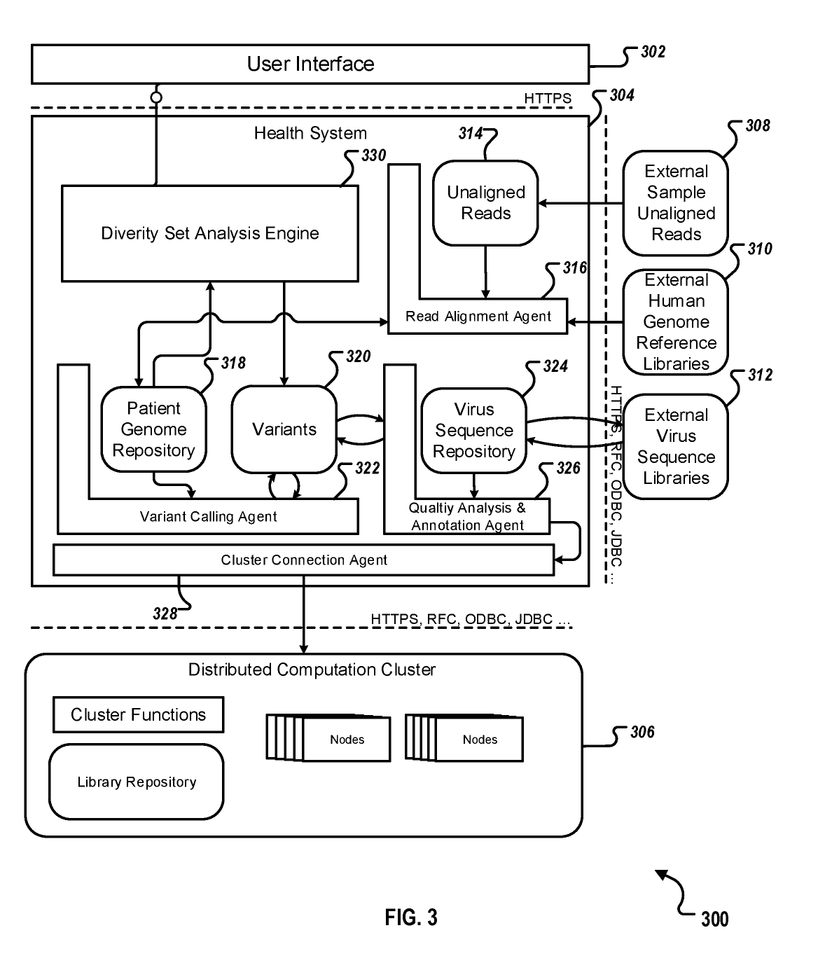

FIG. 3 is a block diagram illustrating an example system 300 for genomic-based virus detection, according to an implementation. The example system 300 includes a health system 304 performing virus detection, a user interface 302 enabling user interaction with the health system 304, and a distributed computation cluster 306 performing computational tasks associated with the virus detection. In some implementations, the distributed computation cluster 306 can include a set of computer nodes that can work together to perform computational tasks using distributed computation approach (such as APACHE SPARK, AWS, HADOOP or SAP HANA VORA). The system 300 can also include external sample unaligned reads 308, external human genome reference libraries 310, and external virus sequence libraries 312 that can be stored in one or more databases or other types of repositories external to the health system 304. In some implementations, the user interface 302 can interact with the health system 304 using communication protocols such as HTTP secure (HTTPS) or other protocols consistent with this disclosure. For example, the user interface 302 can provide a webpage for a user to access the health system 304. The health system 304 can interact with the distributed computation cluster 306, external sample unaligned reads 308, external human genome reference libraries 310, or external virus sequence libraries 312 using communication protocols such as HTTPS, remote function call (RFC), open database connectivity (ODBC), JAVA database connectivity (JDBC) or other protocols consistent with this disclosure.

The health system 304 can include unaligned reads 314, read alignment agent 316, patient genome repository 318, variants 320, variant calling agent 322, virus sequence repository 324, quality analysis and annotation agent 326, cluster connection agent 328, and a diversity set analysis engine 330. In a typical implementation, the read alignment agent 316 receives unaligned DNA reads 314 of a patient's sample and a human reference DNA sequence from the external human genome reference libraries 310. The read alignment agent 316 can align the DNA reads 314 to form an aligned sample DNA sequence based on the human reference sequence. In some cases, the read alignment agent 316 can align the DNA reads 314 based on the patient's previous DNA sequences (for example, DNA sequences of previous samples) from the patient genome repository 318. In some implementations, the unaligned DNA reads 314 are received from a source external to the health system 304, such as the external sample unaligned reads 308. The variant calling agent 322 can identify variants 320 by comparing the aligned sample DNA sequence to the human reference sequence or the patient's previous DNA sequences. The quality analysis and annotation agent 326 can receive virus reference sequences from the virus sequence repository 324 and determine a correlation matrix between the identified variants 320 and the virus reference sequences. Computational tasks, such as DNA string comparisons or other computation consistent with this disclosure, can be sent to the distributed computation cluster 306 through the cluster connection agent 328. For example, the distributed computation cluster 306 can be used to compute the correlation matrix between the variants 320 and the virus reference sequences. Based on the correlation matrix, the diversity set analysis engine 330 can determine virus(es) the patient has been exposed to/infected with, and send the information about the determination to the user interface 302. In some implementations, the health system 304 can be seamlessly integrated into a personalized medical system for analysis using the distributed computation cluster 306.

In some implementations, the virus reference sequences are determined either from the external virus sequence libraries 312 or from the internal virus sequence repository 324. The correlation matrix at step 110 in FIG. 1 is computed based on alignment of the identified variants with all of the known viral DNA sequences. For this alignment the regular read alignment (such as step 106 in FIG. 1) can be re-used with the new reference genome being the known viral DNA sequence. This can be looped over all of the known virus sequences. Due to the short nature of the virus sequence length, such a correlation computation can be done quickly. If there are N identified variants and M known virus sequences, the computation task can also be parallelized efficiently by distributing the N identified variants and the M known virus sequences across the distributed computation cluster 306. The resulting correlation matrix will be a N-by-M matrix, where most entries in the matrix are close to 0. Only the rows and columns with a correlation value greater than a predefined threshold (for example, 0.8) are displayed and sent to the diversity set analysis (step 112 in FIG. 1).

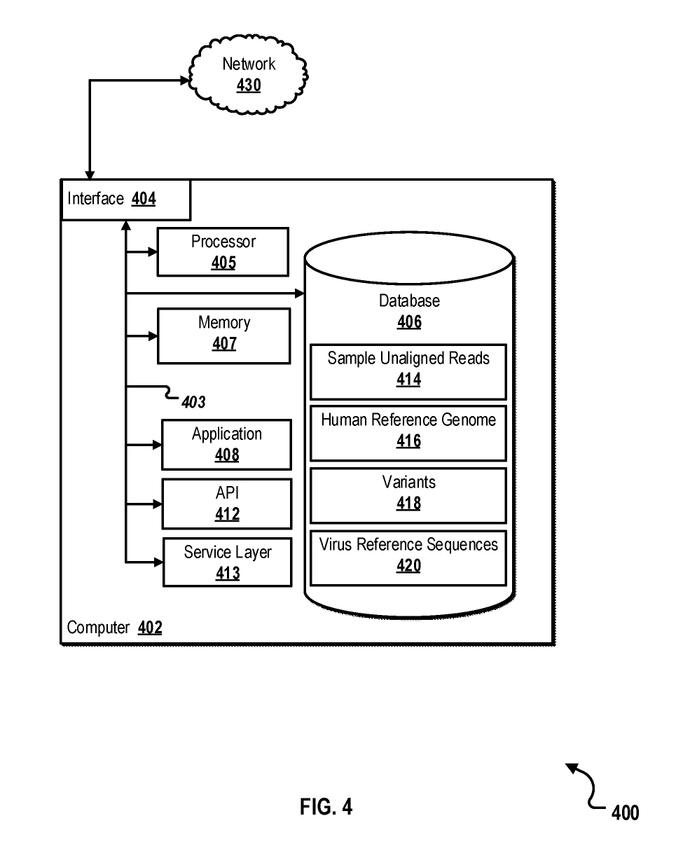

FIG. 4 is a block diagram of an exemplary computer system 400 used to provide computational functionalities associated with described algorithms, methods, functions, processes, flows, and procedures as described in the instant disclosure, according to an implementation. The illustrated computer 402 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual, or audio information (or a combination of information), or a graphical user interface (GUI).

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third-parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application programming interface (API) 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a database 406 that can hold data for the computer 402 or other components (or a combination of both) that can be connected to the network 430 (whether illustrated or not). For example, database 406 can be an in-memory, conventional, or other type of database storing data consistent with this disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases (of the same or combination of types) can be used according to particular needs, desires, or particular implementations of the computer 402 and the described functionality. While database 406 is illustrated as an integral component of the computer 402, in alternative implementations, database 406 can be external to the computer 402. The database 406 can include sample unaligned reads 414, human reference genome 416, variants 418, and virus reference sequences 420.

The computer 402 also includes a memory 407 that can hold data for the computer 402 or other components (or a combination of both) that can be connected to the network 430 (whether illustrated or not). For example, memory 407 can be random access memory (RAM), read-only memory (ROM), optical, magnetic, and the like storing data consistent with this disclosure. In some implementations, memory 407 can be a combination of two or more different types of memory (for example, a combination of RAM and magnetic storage) according to particular needs, desires, or particular implementations of the computer 402 and the described functionality. Although illustrated as a single memory 407 in FIG. 4, two or more memories 407 (of the same or combination of types) can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in this disclosure. For example, application 408 can serve as one or more components, modules, applications, etc. Further, although illustrated as a single application 408, the application 408 may be implemented as multiple applications on the computer 402. In addition, although illustrated as integral to the computer 402, in alternative implementations, the application 408 can be external to the computer 402.

There may be any number of computers 402 associated with, or external to, a computer system containing computer 402, each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

Described implementations of the subject matter can include one or more features, alone or in combination.

For example, in a first implementation, a computer-implemented method includes: receiving a plurality of DNA reads, each DNA read represents a portion of a DNA sequence of a patient's DNA sample; assembling the plurality of DNA reads into an aligned DNA sequence based on a human reference DNA sequence; identifying at least one variant by comparing the aligned DNA sequence to the human reference sequence, each variant represents a difference between the aligned DNA sequence and the human reference sequence; receiving a plurality of virus reference DNA sequences, each virus reference sequence represents a DNA sequence of a virus; and for each identified variant and each of the plurality of virus reference sequences, computing a correlation between the variant and the virus reference sequence.

The foregoing and other described implementations can each optionally include one or more of the following features:

A first feature, combinable with any of the following features, where the method further includes storing the identified at least one plurality of variants in a repository.

A second feature, combinable with any of the previous or following features, where the human reference sequence is a DNA sequence of the patient's previous DNA sample.

A third feature, combinable with any of the previous or following features, where computing the correlation is performed by a distributed computation cluster.

A fourth feature, combinable with any of the previous or following features, where the correlation represents a probability of the variant corresponding to a particular virus.

A fifth feature, combinable with any of the previous or following features, where the method further includes determining at least a one virus the patient has been infected with based on the correlation.

A sixth feature, combinable with any of the previous or following features, where each virus reference DNA sequence is a known viral DNA sequence.

In a second implementation, a non-transitory, computer-readable medium storing one or more instructions executable by a computer system to perform operations including: receiving a plurality of DNA reads, each DNA read represents a portion of a DNA sequence of a patient's DNA sample; assembling the plurality of DNA reads into an aligned DNA sequence based on a human reference DNA sequence; identifying at least one variant by comparing the aligned DNA sequence to the human reference sequence, each variant represents a difference between the aligned DNA sequence and the human reference sequence; receiving a plurality of virus reference DNA sequences, each virus reference sequence represents a DNA sequence of a virus; and for each identified variant and each of the plurality of virus reference sequences, computing a correlation between the variant and the virus reference sequence.

The foregoing and other described implementations can each optionally include one or more of the following features:

A first feature, combinable with any of the following features, where the operations further include storing the identified at least one plurality of variants in a repository.

A second feature, combinable with any of the previous or following features, where the human reference sequence is a DNA sequence of the patient's previous DNA sample.

A third feature, combinable with any of the previous or following features, where computing the correlation is performed by a distributed computation cluster.

A fourth feature, combinable with any of the previous or following features, where the correlation represents a probability of the variant corresponding to a particular virus.

A fifth feature, combinable with any of the previous or following features, where the operations further include determining at least a one virus the patient has been infected with based on the correlation.

A sixth feature, combinable with any of the previous or following features, where each virus reference DNA sequence is a known viral DNA sequence.

In a third implementation, a computer-implemented system includes a computer memory, and a hardware processor interoperably coupled with the computer memory and configured to perform operations including: receiving a plurality of DNA reads, each DNA read represents a portion of a DNA sequence of a patient's DNA sample; assembling the plurality of DNA reads into an aligned DNA sequence based on a human reference DNA sequence; identifying at least one variant by comparing the aligned DNA sequence to the human reference sequence, each variant represents a difference between the aligned DNA sequence and the human reference sequence; receiving a plurality of virus reference DNA sequences, each virus reference sequence represents a DNA sequence of a virus; and for each identified variant and each of the plurality of virus reference sequences, computing a correlation between the variant and the virus reference sequence.

The foregoing and other described implementations can each optionally include one or more of the following features:

A first feature, combinable with any of the following features, where the operations further include storing the identified at least one plurality of variants in a repository.

A second feature, combinable with any of the previous or following features, where the human reference sequence is a DNA sequence of the patient's previous DNA sample.

A third feature, combinable with any of the previous or following features, where computing the correlation is performed by a distributed computation cluster.

A fourth feature, combinable with any of the previous or following features, where the correlation represents a probability of the variant corresponding to a particular virus.

A fifth feature, combinable with any of the previous or following features, where the operations further include determining at least a one virus the patient has been infected with based on the correlation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The methods, processes, logic flows, etc. described in this specification can be performed by one or more programmable computers executing one or more computer programs to perform functions by operating on input data and generating output. The methods, processes, logic flows, etc. can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving a plurality of deoxyribonucleic acid (DNA) reads, each DNA read represents a portion of a DNA sequence of a patient's DNA sample;
assembling the plurality of DNA reads into an aligned DNA sequence based on a human reference DNA sequence;
identifying at least one variant by comparing the aligned DNA sequence to the human reference sequence, each variant represents a difference between the aligned DNA sequence and the human reference sequence;
receiving a plurality of virus reference DNA sequences, each virus reference sequence represents a DNA sequence of a virus; and
for each identified variant and each of the plurality of virus reference sequences, computing a correlation between the variant and the virus reference sequence.

2. The computer-implemented method of claim 1, further comprising storing the identified at least one variant in a repository.

3. The computer-implemented method of claim 1, wherein the human reference sequence is a DNA sequence of the patient's previous DNA sample.

4. The computer-implemented method of claim 1, wherein computing the correlation is performed by a distributed computation cluster.

5. The computer-implemented method of claim 1, wherein the correlation represents a probability of the variant corresponding to a particular virus.

6. The computer-implemented method of claim 1, further comprising determining at least one virus the patient has been infected with based on the correlation.

7. The computer-implemented method of claim 1, wherein each virus reference DNA sequence is a known viral DNA sequence.

8. A non-transitory, computer-readable medium storing one or more instructions executable by a computer system to perform operations comprising:
receiving a plurality of deoxyribonucleic acid (DNA) reads, each DNA read represents a portion of a DNA sequence of a patient's DNA sample;
assembling the plurality of DNA reads into an aligned DNA sequence based on a human reference DNA sequence;
identifying at least one variant by comparing the aligned DNA sequence to the human reference sequence, each variant represents a difference between the aligned DNA sequence and the human reference sequence;
receiving a plurality of virus reference DNA sequences, each virus reference sequence represents a DNA sequence of a virus; and
for each identified variant and each of the plurality of virus reference sequences, computing a correlation between the variant and the virus reference sequence.

9. The non-transitory, computer-readable medium of claim 8, wherein the operations further comprise storing the identified at least one variant in a repository.

10. The non-transitory, computer-readable medium of claim 8, wherein the human reference sequence is a DNA sequence of the patient's previous DNA sample.

11. The non-transitory, computer-readable medium of claim 8, wherein computing the correlation is performed by a distributed computation cluster.

12. The non-transitory, computer-readable medium of claim 8, wherein the correlation represents a probability of the variant corresponding to a particular virus.

13. The non-transitory, computer-readable medium of claim 8, wherein the operations further comprise determining at least one virus the patient has been infected with based on the correlation.

14. The non-transitory, computer-readable medium of claim 8, wherein each virus reference DNA sequence is a known viral DNA sequence.

15. A computer-implemented system, comprising:
a computer memory; and
a hardware processor interoperably coupled with the computer memory and configured to perform operations comprising:
receiving a plurality of deoxyribonucleic acid (DNA) reads, each DNA read represents a portion of a DNA sequence of a patient's DNA sample;
assembling the plurality of DNA reads into an aligned DNA sequence based on a human reference DNA sequence;
identifying at least one variant by comparing the aligned DNA sequence to the human reference sequence, each variant represents a difference between the aligned DNA sequence and the human reference sequence;
receiving a plurality of virus reference DNA sequences, each virus reference sequence represents a DNA sequence of a virus; and
for each identified variant and each of the plurality of virus reference sequences, computing a correlation between the variant and the virus reference sequence.

16. The computer-implemented system of claim 15, wherein the operations further comprise storing the identified at least one variant in a repository.

17. The computer-implemented system of claim 15, wherein the human reference sequence is a DNA sequence of the patient's previous DNA sample.

18. The computer-implemented system of claim 15, wherein computing the correlation is performed by a distributed computation cluster.

19. The computer-implemented system of claim 15, wherein the correlation represents a probability of the variant corresponding to a particular virus.

20. The computer-implemented system of claim 15, wherein the operations further comprise determining at least one virus the patient has been infected with based on the correlation.
